(19) United States
(12) Patent Application Publication
(10) Pub. No.: US 2009/0001926 A1
(43) Pub. Date: Jan. 1, 2009

(54) Electrically Driven Vehicle

(75) Inventor: Eiji Sato, Aichi-ken (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, TOYOTA-SHI (JP)

(21) Appl. No.: 12/087,511

(22) PCT Filed: Jan. 30, 2007
(86) PCT No.: PCT/IB2007/000211

§ 371 Date: Jul. 9, 2008

(30) Foreign Application Priority Data
Feb. 24, 2006 (JP) 2006-048900

(51) Int. Cl. H02J 7/00

(52) U.S. Cl. 320/102

(57) ABSTRACT

A electrically driven vehicle (100) has high-voltage battery (42) for driving an electric motor (10) for driving the vehicle, a solar battery (24), a charging DC/DC converter (36) supplying electrical power generated by the solar battery (24) to the high-voltage battery (42), a charging control ECU (38) that performs charging control of the charging DC/DC converter (36) for charging the high-voltage battery (42), and a low-voltage power supply DC/DC converter (34) that receives a part of the electrical power generated by the solar battery (24) and generates a power supply voltage that is supplied to the charging control ECU (38).

### BACKGROUND OF THE INVENTION

1. Field of the Invention

The present invention relates to an electrically driven vehicle, and more particularly to an electrically driven vehicle in which are installed a solar battery and a storage battery.

2. Description of Related Art

Art related to an electrically driven vehicle has been disclosed (for example, in Japanese Patent Application Publications No. JP-A-5-111112, JP-A-11-178228, JP-A-6-78473, JP-A-2005-282428, and JP-A-5-244732). In particular, Japanese Patent Application Publication No. JP-A-5-111112 discloses an electrically driven vehicle having a main battery for driving the driving motor, an auxiliary equipment motor for driving auxiliary equipment (hereinafter “sub-battery”), a solar battery for charging the batteries, a selecting switch for selectively connecting the solar battery to the other batteries, an operation control means for causing operation of the solar battery at the point at which the electrical power output thereof is maximum, and a charging control means that controls the selecting switch so as selectively charge the main battery and sub-battery responsive to size of electrical power output of the solar battery.

In the case of carrying a solar battery and performing charging of a main battery, it is necessary to monitor amount of sunlight and the condition of the battery. It is necessary to supply a stable 12-volt power supply to an electrical circuit for the purpose of this type of monitoring. In a vehicle, this power supply voltage is often supplied by a stable sub-battery. In Japanese Patent Application Publication No. JP-A-5-111112, there is no language with regard to the supply of power to a monitoring circuit.

However, if the sub-battery is depleted for the purpose of performing monitoring, for example, of the amount of sunlight when charging the main battery, even if the main battery is charged, there is the problem of a decrease in the amount of charge of the sub-battery.

### SUMMARY OF THE INVENTION

The present invention has an object to provide an electrically driven vehicle capable of charging a main battery using a solar battery, while suppressing a decrease in the voltage of a sub-battery.

A first aspect of the present invention relates to an electrically driven vehicle that includes a main battery for driving an electric motor for driving the vehicle, a solar battery, a first voltage converter supplying electrical power generated by the solar battery to the main battery, and a control unit performing charging control of the first voltage converter for charging the main battery. This electrically driven vehicle also has a second voltage converter receiving a part of the electrical power generated by the solar battery and generating a power supply voltage supplied to the control unit.

According to the first aspect, it is possible to supply a power supply voltage from the second voltage converter to the control unit. For this reason, it is possible to suppress a decrease in the amount of charge of the battery, without depleting the electrical power of the battery. It is additionally possible to mount the solar battery in a mobile unit. For this reason, it is possible to charge the battery without restriction to a specific location, such as the location of a commercial power source. Also, because a solar battery provides a DC power source, it is possible to supply electrical power to the battery without converting from AC to DC.

This electrically driven vehicle may further have a main relay that is provided on a power supply path joining the main battery and the electric motor. The control unit may control the main relay so as to open the main relay when performing charging of the main battery by using electrical power of the solar battery in a case in which electric motor is not used.

By doing this, it is possible by opening of the main relay at the time of charging using the solar battery to reduce the electrical power consumption of the sub-battery without regard to the charging by the drive power control unit (PCU).

The electrically driven vehicle may further have a charging relay that is provided on a charging current path joining the solar battery and the main battery. In the case in which the electrical power of the solar battery is used to charge the main battery, the control unit may control the charging relay so as to close the charging relay.

The control unit may perform control so as to open the charging relay when an abnormality occurs in at least any one of the main battery, the first voltage converter, and the solar battery.

The electrically driven vehicle may further comprise a first housing that houses the main battery and the first voltage converter. The solar battery may be installed outside the first housing.

By doing this, it is possible to improve the safety by separating the high-voltage parts from the low-voltage parts.

The electrically driven vehicle may further have a sub-battery that supplies a power supply voltage to an auxiliary equipment load and a monitoring unit that monitors a condition of the main battery. The monitoring unit may receive a power supply voltage from the second voltage converter in the case in which the electrical power of the solar battery is used to charge the main battery, and receive the power supply voltage from the sub-battery in during the time that the second voltage converter is stopped. For this reason, when the main battery is being charged, it is possible to operate the monitoring unit by supplying a power supply voltage from the second voltage. By doing this, because it is possible to supply a power supply voltage for the monitoring unit from the second voltage converter rather than from the sub-battery, it is possible to suppress a decrease in the amount of charge of the sub-battery by not consuming electrical power from the sub-battery.

The second voltage converter may generate a voltage that is substantially the same as a voltage of the sub-battery. Also, the electrically driven vehicle may further comprise a third voltage converter that converts a voltage of the main battery and supply the converted voltage to the sub-battery and the auxiliary equipment load.

The monitoring unit may receive a power supply voltage converted by the third voltage converter, and the electrically driven vehicle may further have a main relay, that is provided on a power supply path joining the main battery and the electric motor and a second housing, that houses the main battery, the main relay, the first and second voltage converters, and the monitoring unit. The solar battery is disposed outside the second housing.

The solar battery may be installed in a mobile unit and be mobile.

According to the present invention, it is possible to suppress a decrease in the charge amount of the sub-battery when charging the main battery using the solar battery.

### BRIEF DESCRIPTIONS OF THE DRAWINGS

The foregoing and further objects, features, and advantages of the invention will become apparent from the following description of the preferred embodiments with reference to the accompanying drawings, wherein like numerals are used to represent like elements and wherein:

FIG. 1 is a block diagram showing an electrically driven vehicle 100 in which is installed a solar battery charging system according to the first embodiment of the present invention;

FIG. 2 is a flowchart showing the control of the relay control program executed by the motor control ECU 15 of FIG. 1; and

FIG. 3 is a flowchart showing the control of the relay control program executed by the ECU 38 of FIG. 1.

### DETAILED DESCRIPTION OF THE PREFERRED EMBODIMENTS

The first embodiment of the present invention is described in detail below, with references made to the accompanying drawings. Corresponding or the same elements in the drawings are assigned the same reference numerals and are not described herein.

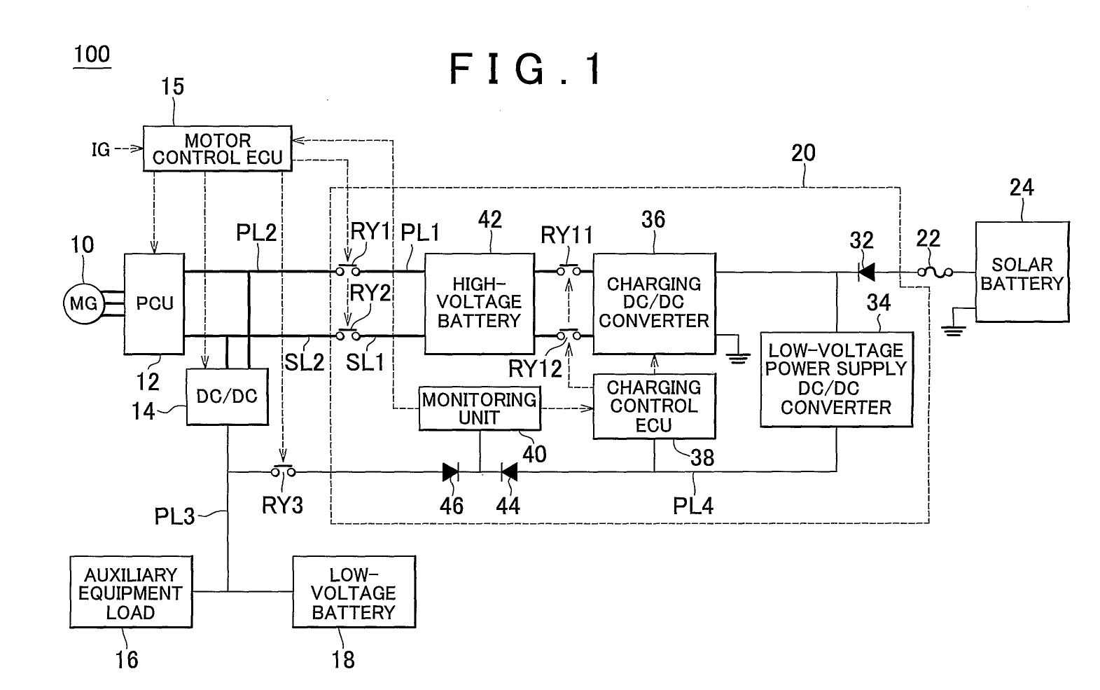

FIG. 1 is a block diagram showing the configuration of the electrically driven vehicle 100 into which is installed a solar battery charging system according to the first embodiment. This solar battery charging system is not restricted to use in an electric vehicle, and can also be applied to a hybrid vehicle having an engine and a motor and using fuel and electricity, and to other electrically driven vehicles, such as a fuel cell vehicle.

Referring to FIG. 1, the electrically driven vehicle 100 includes a high-voltage battery 42 for driving a motor 10 for driving a vehicle, a solar battery 24, a charging DC/DC converter 36 that supplies electrical power generated by the solar battery 24 to the high-voltage battery 42, a charging control ECU 38 that performs control of the charging DC/DC converter 36 in charging the high-voltage battery 42, and a low-voltage power supply DC/DC converter 34 that receives a part of the electrical power generated by the solar battery 24 and generates a power supply voltage that is supplied to the charging control ECU 38. The solar battery 24 can be mounted in a vehicle and can be mobile. The solar battery 24 is connected to the charging DC/DC converter 36 and the low-voltage power supply DC/DC converter 34 via a fuse 22 and a reverse-current preventing diode 32.

If the amount of sunlight is small, because the low-voltage power supply DC/DC converter 34 does not generate a low-voltage power supply voltage, the charging control ECU 38 does not operate and the charging operation stops. If the amount of sunlight is great, however, the low-voltage power supply DC/DC converter 34 generates a low-voltage power supply voltage, and the charging control ECU 38 operates. For this reason, the charging operation is automatically started.

The charging control ECU 38 operates by electrical power generated by the solar battery 24. For example, in the case in which the electrically driven vehicle 100 is a hybrid vehicle, even if the engine is stopped and the vehicle is parked and the low-voltage battery 18 (also known as the auxiliary equipment 12-V battery) is not being charged by the alternator, it is possible to avoid complete depletion of the low-voltage battery 18 because of the operation of the charging control ECU 38 and the like. Also, even in the case, for example, in which the vehicle is stored in a dark place for a long period of time, because the electrical power of the 12-V system low-voltage battery 18 is not used for control of charging control, it is possible to reduce the possibility of the complete depletion of the low-voltage battery 18.

The electrically driven vehicle 100 also includes system main relays RY1, RY2 that are provided on the power supply paths that join the high-voltage battery 42 and the motor 10, and a DC/DC converter 14. Specifically, the system main relay RY1 is provided in between the power supply line PL1 on the high-voltage battery 42 side and the power supply line PL2 on the power control unit 12 side. The system main relay RY2 is provided in between the ground SL1 on the high-voltage battery 42 side and the ground line SL2 on the power control unit 12 side.

The charging control ECU 38 controls the system main relays RY1, RY2 so that they are in the open condition when the charging is done of the high-voltage battery 42 using the electrical power of the solar battery 24 for the case of not using the motor 10. By doing this, when the vehicle is parked in a parking lot, for example, the high-voltage power supply load and the low-voltage power supply load that monitors the high-voltage power supply load are placed in the power-off condition, thereby reducing unnecessary consumption of electrical power. The high-voltage power supply load that is placed in the off condition is, for example, the power control unit 12 that includes an inverter or voltage-boosting converter or the like that drives the motor 10 or the DC/DC converter 14. The low-voltage power supply load that is placed in the off condition is a part of the function of the motor control ECU 15 that monitors abnormalities in the high-voltage power supply load, or the auxiliary equipment load 16 and the like.

The electrically driven vehicle 100 additionally includes charging relays RY11, RY12, which are provided in the charging current supply paths that join the solar battery 24 and the high-voltage battery 42, which is the main battery. Specifically, the charging relay RY11 is provided between the power supply line on the high-voltage battery 42 side and the power supply line on the charging DC/DC converter 36 side. The charging relay RY12 is provided between the ground line on the high-voltage battery 42 side and the ground line on the charging DC/DC converter 36 side.

The charging control ECU 38 controls the closed condition of the charging relays RY11, RY12 in the case in which the electrical power of the solar battery 24 is used to charge the high-voltage battery 42.

In the case in which the system main relays RY1, RY2 are used also as charging relays, a high voltage is applied to the power control unit 12 as well. For this reason, in order to prevent abnormalities, it is necessary that the abnormality detection function and the failsafe function of the power control unit 12 be caused to operate. The power consumption of the power control unit 12 and the motor control ECU 15 and the like increases commensurate with this abnormality prevention, resulting in a reduction in electrical power for charging.

The electrically driven vehicle 100 additionally includes a low-voltage battery 18 that supplies a power supply voltage to the auxiliary equipment load 16 and a monitoring unit 40 that monitors the condition of the high-voltage battery 42.

By providing the charging relays RY11, RY12 separately from the system main relays RY1, RY2 and using them exclusively for charging, it is possible to prevent a reduction in charging electrical power. That is, when charging the high-voltage battery 42 from the solar battery while parked, the minimum functions needed for charging are caused to operate, these being charging control by the charging control ECU 38 and the monitoring unit 40, and the abnormality detection and failsafe functions with regard to charging control. By doing this, the power consumed by parts that are isolated by the system main relays RY1, RY2 is reduced, and it is possible to efficiently use the limited solar energy.

As abnormality detection and failsafe functions regarding charging control, the charging control ECU 38 controls the charging relays RY11, RY12 so as to be in the open condition when an abnormality occurs in at least one of the high-voltage battery 42, charging DC/DC converter 36, and solar battery 24. It is necessary to avoid overcharging of the high-voltage battery 42. For this reason, by not only stopping the charging DC/DC converter 36 but also opening the charging path by using the charging relays RY11, RY12 as well, it is possible to perform reliable charging.

The monitoring unit 40 receives supply of a power supply voltage from the low-voltage power supply DC/DC converter 34 in the case in which the electrical power of the solar battery 24 is used to charge the high-voltage battery 42, and receives supply of a power supply voltage from the low-voltage battery 18 during the time that the low-voltage power supply DC/DC converter 34 is stopped. The low-voltage power supply DC/DC converter 34 generates a voltage that is substantially the same as the 12-V of the low-voltage battery 18.

Because supply is received of power supply current from two power supplies, the monitoring unit 40 has diodes 44, 46 connected to its power supply terminal. The diodes 44, 46 form an OR circuit. Specifically, if one of the two power supplies is activated, it is possible for the monitoring unit 40 to be supplied power and operate.

The DC/DC converter 14 converts the voltage of the high-voltage battery 42 and supplies the converted voltage to the low-voltage battery 18 and the auxiliary equipment load 16. The monitoring unit 40 receives the power supply voltage converted by the DC/DC converter 14 via the relay RY3.

The electrically driven vehicle 100 further includes an housing 20 that houses the high-voltage battery 42, the system main relays RY1, RY2, the charging DC/DC converter 36, the low-voltage power supply DC/DC converter 34, and the monitoring unit 40. The solar battery 24 is installed outside the housing 20.

That is, if the high-voltage battery 42, the charging DC/DC converter 36, and the charging relays RY11, RY12 are housed in one and the same housing 20, the connection to the high-voltage line for charging is made within the housing 20, If this is done, there are only two high-voltage lines connected to the outside from the housing 20, the power supply line PL2 and the ground line SL2. If the system main relays RY1, RY2 are provided in this part, the relays are provided at the exit of the high-voltage lines to the outside from the housing 20, and it is possible to prevent abnormally excessive current from flowing when the vehicle is parked and in the case of a failure. Because all of the other lines for connection to the outside from the housing 20, for example the line from the solar battery 24 and the power supply line PL3 from the relay RY3 are low voltages below 42 V, a relay does not need to be provided within the housing 20.

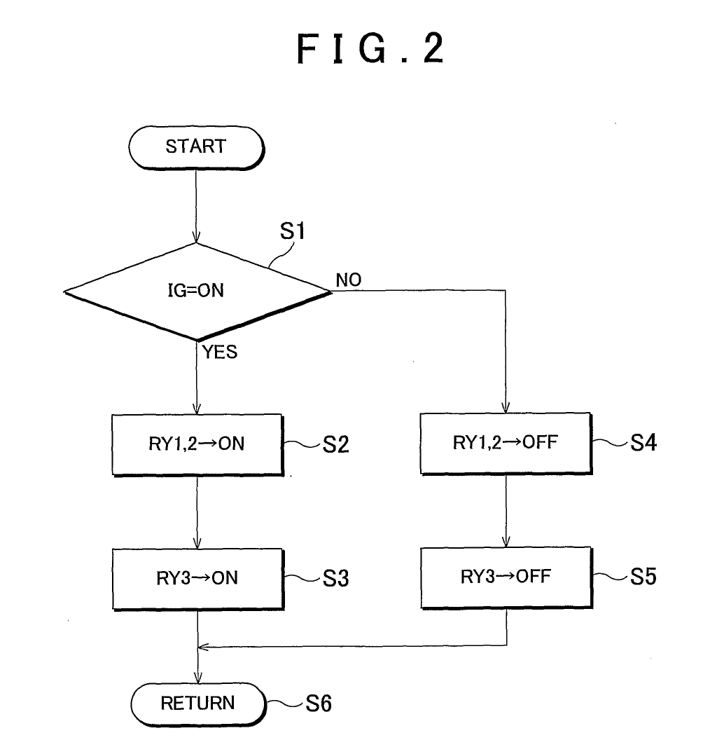

FIG. 2 is a flowchart showing the control of the relay control program executed by the motor control ECU 15 of FIG. 1. The processing in this flowchart is called by the main routine and executed, either every prescribed period of time or when a prescribed condition is satisfied.

Referring to FIG. 1 and FIG. 2, at step S1 the motor control ECU 15 observes the signal IG and makes a judgment as to whether or not the driver has set the ignition key switch to on. If the ignition key switch is in the on condition, processing proceeds to step S2, and if the ignition key switch is in the off condition, processing proceeds to step S4.

At step S2 the motor control ECU 15 controls the system main relays RY1, RY2 so as to be closed and connects the high-voltage battery 42 to the power control unit 12. At step S3 the relay RY3 is electrically closed and the 12-V power that is generated by the DC/DC converter 14 is supplied to the monitoring unit 40.

In contrast, at step S4 the motor control ECU 15 controls the system main relays RY1, RY2 so as to be open, so as to cut the power control unit 12 off from the high-voltage battery 42. Then, at step S5 the relay RY3 is controlled so as to be open, so that the DC/DC converter 14 and the monitoring unit 40 are separated, and so as to stop the operation of the DC/DC converter 14.

When the processing at step S3 or step S5 is completed, control transfers to the main routine at step S6.

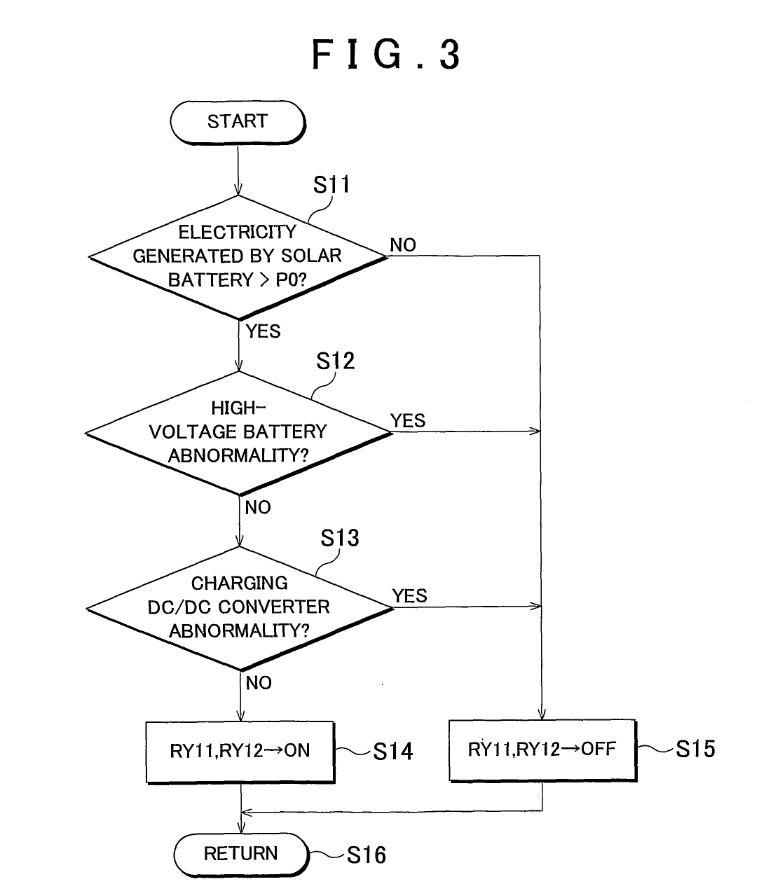

FIG. 3 is a flowchart showing the control of a relay control program executed by the charging control ECU 38 of FIG. 1. The processing in this flowchart is called by the main routine and executed, either every prescribed period of time or when a prescribed condition is satisfied.

Referring to FIG. 1 and FIG. 3, first at step S11 the charging control ECU 38 makes a judgment as to whether or not the amount of electricity generated by the solar battery 24 exceeds a prescribed value P0. The prescribed value P0 is an amount of generated electricity that is required for the solar battery 24 to drive the charging DC/DC converter 36 and charge the high-voltage battery 42. For example, in the case in which the low-voltage power supply DC/DC converter 34 is sending a sufficient power supply voltage to the power supply line PL4, the charging control ECU 38 makes the judgment that the amount of generated electricity exceeds the prescribed value P0. It is also possible to adopt a configuration in which the amount of electricity generated is monitored as a voltage or current, or a configuration in which, separate from the solar battery 24, the amount of sunlight is measured.

At step S11 the processing proceeds to step S12 in the case of the amount of electricity generated by the solar battery exceeds P0, and the processing proceeds to step S15 if the electricity generated amount does not exceed P0.

At step S12, a judgment is made as to whether or not there is an abnormality in the high-voltage battery 42. The charging control ECU 38 makes this judgment based on information sent from the monitoring unit 40. For example, in the case in which the high-voltage battery 42 is fully charged and further charging would result in overcharging, in the case in which the temperature of the high-voltage battery 42 is exceeds a prescribed threshold, and the case in which the voltage variation in the cells of the high-voltage battery 42 is greater than a prescribed value, the charging control ECU 38 makes the judgment that an abnormality has occurred in the high-voltage battery 42.

If there is no abnormality in the high-voltage battery 42 at step S12 processing proceeds to step S13, and if there is an abnormality, processing proceeds to step S15.

At step S13, a judgment is made as to whether or not there is an abnormality in the charging DC/DC converter 36. The charging control ECU 38 makes the judgment that there is an abnormality in the charging DC/DC converter 36, for example, in the case in which the voltage or current of the charging DC/DC converter 36 being monitored is not in accordance with a control signal from the charging control ECU 38. For example, the judgment of an abnormality existing is made if charging current continues to be fed to the high-voltage battery 42 from the charging DC/DC converter 36 in spite of the fact that the charging DC/DC converter 36 should have been stopped in accordance with a control signal from the charging control ECU 38.

If an abnormality exists in the charging DC/DC converter 36 at step S13, processing proceeds to step S14, and if there is no abnormality, processing proceeds to step S15.

At step S14, the charging control ECU 38 closes the charging relays RY11, RY12 so that the high-voltage battery 42 can be charged. At step S15, however, the charging control ECU 38 opens the charging relays RY11, RY12 so as to stop the charging.

When the processing at step S14 or step S15 is completed, control transfers to the main routine at step S16.

As described above, by providing a charging relay and performing control thereof separately from the system main relay, it is possible to provide electrical drive so as to charge with the minimal required configuration. It is also possible to perform efficient charging with the limited amount of electrical power generated by the solar battery. In addition, because the electrical power of the 12-V system battery is not used for charging operation, in the case, for example, in which the vehicle is left parked in a dark location for a long period of time, it is possible to reduce the possibility that the 12-V system battery will become completely depleted.

The above-disclosed embodiments of the present invention are exemplary, and should be understood as not being restrictive. The scope of the present invention is indicated not by the above-noted description, but rather by the claims, and it is intended that the all variations having an equivalent meaning and within the scope of the claims are encompassed.

1. An electrically driven vehicle comprising:
a main battery that drives an electric motor for driving said vehicle
a solar battery,
a first voltage converter that supplies electrical power generated by the solar battery to the main battery,
a control unit that performs charging control of the first voltage converter for charging the main battery, and
a second voltage converter that receives a part of the electrical power generated by the solar battery and generates a power supply voltage supplied to the control unit.

2. The electrically driven vehicle according to claim 1, wherein:
the control unit receives the power supply voltage only from the second voltage converter.

3. The electrically driven vehicle according to claim 1, further comprising:
a main relay that is provided on a power supply path joining the main battery and the electric motor, wherein
the control unit controls the main relay so as to open the main relay when performing charging of the main battery by using electrical power of the solar battery if the electric motor is not used.

4. The electrically driven vehicle according to claim 1, further comprising:
a charging relay that is provided on a charging current supply path joining the solar battery and the main battery, wherein
the control unit controls the charging relay so as to close the charging relay when performing charging of the main battery by using electrical power of the solar battery.

5. The electrically driven vehicle according to claim 4, wherein
the control unit opens the charging relay when an abnormality occurs in at least one of the main battery, the first voltage converter, and the solar battery.

6. The electrically driven vehicle according to claim 1, further comprising:
a first housing that houses the main battery and the first voltage converter, wherein
the solar battery is disposed outside the first housing.

7. The electrically driven vehicle according to claim 1, further comprising:
a sub-battery that supplies a power supply voltage to an auxiliary equipment load; and
a monitoring unit that monitors a condition of the main battery, wherein
the monitoring unit receives the power supply voltage from the second voltage converter if the electrical power of the solar battery is used to charge the main battery, and receives the power supply voltage from the sub-battery when the second voltage converter is stopped.

8. The electrically driven vehicle according to claim 7, wherein
the second voltage converter generates a voltage that is substantially the same as a voltage of the sub-battery.

9. The electrically driven vehicle according to claim 7, further comprising:
a third voltage converter that converts a voltage from the main battery and supplies the converted voltage to the sub-battery and the auxiliary equipment load.

10. The electrically driven vehicle according to claim 9, wherein
the monitoring unit receives the converted voltage from the third voltage converter, the electrically driven vehicle further comprising:
a main relay that provides on a power supply path joining the main battery and the electric motor; and
a second housing that houses the main battery, the main relay, the first and second voltage converters, and the monitoring unit, wherein
the solar battery is disposed outside the second housing.
